(19) United States
(12) Patent Application Publication
(10) Pub. No.: US 2025/0367556 A1
(43) Pub. Date: Dec. 4, 2025

(54) VIRTUAL OBJECT CONTROL

(71) Applicant: Tencent Technology (Shenzhen) Company Limited, Shenzhen (CN)

(72) Inventor: Yu GUAN, Shenzhen (CN)

(73) Assignee: Tencent Technology (Shenzhen) Company Limited, Shenzhen (CN)

(21) Appl. No.: 19/308,092

(22) Filed: Aug. 22, 2025

Related U.S. Application Data
(63) Continuation of application No. PCT/CN2024/086454, filed on Apr. 7, 2024.

(30) Foreign Application Priority Data
Jun. 9, 2023 (CN) 202310684450.6

(51) Int. Cl. A63F 13/55; A63F 13/24; A63F 13/52; A63F 13/5375; G06T 13/40; G06T 19/20

(52) U.S. Cl. CPC A63F 13/55; A63F 13/24; A63F 13/52; A63F 13/5375; G06T 13/40; G06T 19/20; G06T 2219/2004

(57) ABSTRACT

In a virtual object control method, a virtual scene of a virtual environment is output for display. The virtual scene includes a virtual object located in the virtual environment. The virtual object is controlled to perform an action in the virtual environment. An action control element in one of a plurality of forms is output for display based on a current movement state of the virtual object. The action control element is displayed in a first form of the plurality of forms based on the current movement state being a non-flight state. The action control element is displayed in a second form of the plurality of forms based on the current movement state being a flight state.

### RELATED APPLICATIONS

The present application is a continuation of International Application No. PCT/CN2024/086454, filed on Apr. 7, 2024, which claims priority to Chinese Patent Application No. 202310684450.6, entitled “VIRTUAL OBJECT CONTROL METHOD AND APPARATUS, DEVICE, STORAGE MEDIUM, AND PROGRAM PRODUCT”, and filed on Jun. 9, 2023, which are incorporated herein by reference in their entirety.

### FIELD OF THE TECHNOLOGY

Embodiments of this application relate to the field of human-computer interaction technologies, including to a virtual object control method and apparatus, a device, a storage medium, and a program product.

### BACKGROUND OF THE DISCLOSURE

Currently, with the gradual enrichment of game content and functions, virtual objects with flight capabilities have appeared in games.

In the related art, a user interface of a game application includes a joystick operation control and an altitude adjustment operation control. The joystick operation control is configured to control movement of a virtual object in a horizontal direction, including movement in each horizontal direction such as forward, backward, left, or right. The altitude adjustment operation control is configured to control movement of the virtual object in a vertical direction, including movement in two directions: upward and downward. If a user does not adjust a flight altitude of the virtual object through the altitude adjustment operation control, the virtual object maintains its current flight altitude to fly.

However, in the solution provided in the related art, the user interface has a large quantity of controls, making it inconvenient for players to operate, resulting in low human-computer interaction efficiency.

### SUMMARY

This disclosure provides a virtual object control method and apparatus, a device, a storage medium, and a program product. Technical solutions include the following:

According to an aspect of this disclosure, a virtual object control method is provided. In the method, a virtual scene of a virtual environment is output for display. The virtual scene includes a virtual object located in the virtual environment. The virtual object is controlled to perform an action in the virtual environment. An action control element in one of a plurality of forms is output for display based on a current movement state of the virtual object. The action control element is displayed in a first form of the plurality of forms based on the current movement state being a non-flight state. The action control element is displayed in a second form of the plurality of forms based on the current movement state being a flight state.

According to an aspect of this disclosure, a virtual object control apparatus is provided. The apparatus includes processing circuitry that is configured to output for display a virtual scene of a virtual environment. The virtual scene includes a virtual object located in the virtual environment. The processing circuitry is configured to control the virtual object to perform an action in the virtual environment. The processing circuitry is configured to output for display an action control element in one of a plurality of forms based on a current movement state of the virtual object. The action control element is displayed in a first form of the plurality of forms based on the current movement state being a non-flight state. The action control element is displayed in a second form of the plurality of forms based on the current movement state being a flight state.

According to an aspect of this disclosure, a virtual object control method is provided. The method includes: displaying a virtual environment picture, the virtual environment picture including a virtual object located in a virtual environment; controlling the virtual object to perform an action in the virtual environment; and displaying an action control in a current form based on a current movement state of the virtual object, the current movement state being a flight state or a non-flight state, the current form being corresponding to the current movement state, and the action control in the current form being configured to implement a control function in the current movement state.

According to an aspect of this disclosure, a virtual object control apparatus is provided. The apparatus includes: a display module, configured to display a virtual environment picture, the virtual environment picture including a virtual object located in a virtual environment; and a control module, configured to control the virtual object to perform an action in the virtual environment, the display module being configured to display an action control in a current form based on a current movement state of the virtual object, the current movement state being a flight state or a non-flight state, the current form being corresponding to the current movement state, and the action control in the current form being configured to implement a control function in the current movement state.

According to another aspect of this disclosure, a computer device is provided. The computer device includes a processor and a memory, the memory having at least one computer program stored therein, the at least one computer program being loaded and executed by the processor to implement any of the virtual object control methods described herein.

According to another aspect of this disclosure, a computer storage medium is provided. The computer storage medium has at least one computer program stored therein, the at least one computer program being loaded and executed by a processor to implement any of the virtual object control methods described herein.

According to another aspect of this disclosure, a computer program product is provided. The computer program product includes a computer program, the computer program being stored in a computer-readable storage medium; and the computer program being read from the computer-readable storage medium and executed by a processor of a computer device, to cause the computer device to perform any of the virtual object control methods described herein.

Beneficial effects brought by the technical solutions provided in this disclosure include at least the following.

In this disclosure, when the virtual object is in the flight state, an action control in a flight form is displayed; and when the virtual object is in the non-flight state, an action control in a non-flight form is displayed. In other words, in this disclosure, the action control in the flight form and the action control in the non-flight form are combined, so that different control functions are performed through different forms of one action control, thereby avoiding the need for an additional action control to control flight, reducing an area occupied by the controls on a user interface, facilitating user operation, and improving human-computer interaction efficiency.

### BRIEF DESCRIPTION OF THE DRAWINGS

FIG. 1 is a schematic diagram of a virtual object control method according to an embodiment of this disclosure.

FIG. 2 is a schematic architectural diagram of a computer system according to an embodiment of this disclosure.

FIG. 3 is a flowchart of a virtual object control method according to an embodiment of this disclosure.

FIG. 4 is a schematic diagram of a transformation process from a three-dimensional space into a two-dimensional image according to an embodiment of this disclosure.

FIG. 5 is a flowchart of a virtual object control method according to an embodiment of this disclosure.

FIG. 6 is a schematic diagram of an action control according to an embodiment of this disclosure.

FIG. 7 is a schematic diagram of triggering an action control according to an embodiment of this disclosure.

FIG. 8 is a schematic diagram of triggering an action control according to an embodiment of this disclosure.

FIG. 9 is a schematic diagram of triggering an action control according to an embodiment of this disclosure.

FIG. 10 is a schematic diagram of triggering an action control according to an embodiment of this disclosure.

FIG. 11 is a schematic diagram of triggering an action control according to an embodiment of this disclosure.

FIG. 12 is a flowchart of a virtual object control method according to an embodiment of this disclosure.

FIG. 13 is a block diagram of a virtual object control apparatus according to an embodiment of this disclosure.

FIG. 14 is a schematic structural diagram of a computer device according to an embodiment of this disclosure.

### DESCRIPTION OF EMBODIMENTS

First, examples of terms involved in the embodiments of this disclosure are introduced. The descriptions of the terms are provided as examples only and are not intended to limit the scope of the disclosure.

Virtual environment: It is a virtual environment displayed (or provided) by an application when running on a terminal. The virtual environment may be a simulated environment of a real world, or may be a semi-simulated and semi-fictional environment, or may be a completely fictional environment. The virtual environment may be any one of a two-dimensional virtual environment, a 2.5-dimensional virtual environment, and a three-dimensional virtual environment. This is not limited in this disclosure. A description is made by using an example in which the virtual environment is a three-dimensional virtual environment in the following embodiments.

Virtual object: It refers to a movable character in a virtual environment. The movable character may be a virtual person, a virtual animal, an animated character, or the like, for example, a person, an animal, a plant, a wall, a stone, or a pool displayed in the virtual environment. The virtual object is controlled by a user. Virtual objects may be classified based on their roles, such as pharmacists, magicians, or healers; or may be classified based on their categories, such as humans, beasts, or immortals. Each virtual object has its own shape and volume in the virtual environment, occupying a part of space in the virtual environment.

Multiplayer online game: It refers to a game where the server can support a large number of players simultaneously online, and is also named as a massive multiplayer online role-playing game. The game provides users with a virtual world where they can create virtual objects, and control the virtual objects to perform corresponding actions, to complete tasks corresponding to the actions. Virtual objects controlled by a plurality of users may form a team, to complete the same task together or fight against another team.

Joystick operation control: By dragging the control, a virtual object is controlled to move in a horizontal direction, including movement in each horizontal direction such as forward, backward, left, or right.

X/Y/Z axis: In a game, X represents forward and backward, Z represents left and right, and Y represents upward and downward. When a virtual object moves along the X/Z axis, it means movement on a horizontal plane, including forward, backward, left, and right. When the virtual object moves along the Y axis, it means a vertical change in altitude.

Tap operation: It is an operation mode in which a finger is pressed on a button/region on a screen and the finger is then quickly released.

Long-press operation: It is an operation mode in which a finger is pressed and held on a button/region on a screen without being released.

Slide operation: It is an operation mode in which a finger is pressed and held on a button/region on a screen, and the finger is dragged in a direction for a distance (beyond a specific range from an original tap position) before being released.

Drag operation: It is an operation mode in which a finger is pressed and held on a button/region on a screen, and the finger is dragged in a direction for a distance (beyond a specific range from an original tap position) while the finger is continuously held.

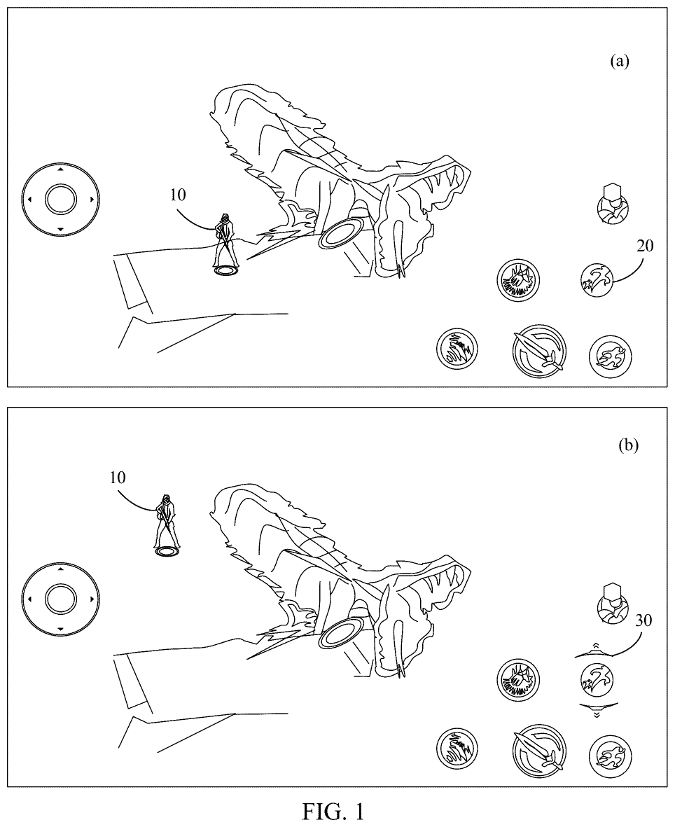

The embodiments of this disclosure provide a schematic diagram of a virtual object control method. As shown in FIG. 1, the method may be performed by a computer device, and the computer device includes a terminal.

In an example, the computer device displays a virtual environment picture. The virtual environment picture includes a virtual object 10 located in a virtual environment. The computer device controls the virtual object 10 to perform an action in the virtual environment. The computer device displays an action control in a current form based on a current movement state of the virtual object 10. The current form is corresponding to the current movement state, and the action control in the current form is configured to implement a control function in the current movement state.

The action control refers to a control obtained through combination of sub-controls providing different control functions, or a control that can provide at least two control functions. For example, the action control can not only control the virtual object 10 to dodge and teleport, but also control the virtual object 10 to fly.

The current movement state is a flight state or a non-flight state. The movement state refers to a state related to the virtual object 10, or a position state of the virtual object 10 in the virtual environment, or a motion state of the virtual object 10 in the virtual environment, but is not limited thereto.

The flight state refers to a state in which the virtual object 10 is hovers in the air.

In some embodiments, the non-flight state includes any one of a grounded state, a solo state, an auxiliary item loading state, a cooldown state, and a berserk state, but is not limited thereto. This is not specifically limited in the embodiments of this disclosure.

The grounded state refers to a state in which the virtual object 10 is located on the ground in the virtual environment, or the grounded state means that feet of the virtual object 10 have support in the virtual environment.

The solo state means that the virtual object 10 in action does not carry an auxiliary item, or the solo state refers to a state in which the virtual object 10 relies on itself for action.

The auxiliary item loading state means that the virtual object 10 in action carries an auxiliary item, or the auxiliary item loading state refers to a state in which the virtual object 10 relies on a loaded auxiliary item for action. In some embodiments, the auxiliary item includes at least one of a virtual carrier, a virtual pet, and virtual equipment, but is not limited thereto. This is not specifically limited in the embodiments of this disclosure. In some embodiments, the virtual carrier includes at least one of a virtual plane, a virtual tank, a virtual armored vehicle, and a virtual motorcycle.

The cooldown state means that the virtual object 10 in action is moving at a constant speed, or the virtual object 10 is acting in a normal mode, or a movement speed of the virtual object 10 has an upper limit.

The berserk state means that the virtual object 10 in action is moving at an increasing speed, or the virtual object 10 is acting in an accelerated mode, or a movement speed of the virtual object 10 has no upper limit and can increase indefinitely.

In some embodiments, when the current movement state of the virtual object 10 is the grounded state, as shown in part (a) in FIG. 1, the computer device displays a dodge sub-control 20 in the action control in response to the virtual object 10 being in the grounded state. In some embodiments, the grounded state includes: the virtual object 10 standing on the ground, the virtual object 10 standing on a rock, the virtual object 10 running on the grass, and the virtual object 10 crawling on the grass, but is not limited thereto. This is not specifically limited in the embodiments of this disclosure.

In this case, the dodge sub-control 20 is configured to control the virtual object to perform a dodge action on the ground or perform state switching of the virtual object 10. In some embodiments, the dodge sub-control 20 may control, in different trigger manners, the virtual object 10 to perform the dodge action or perform the state switching of the virtual object 10. For example, by short pressing the dodge sub-control 20, the virtual object 10 is controlled to perform the dodge action, or by long pressing the dodge sub-control 20, the state switching of the virtual object 10 is performed.

The state switching refers to switching a state of the virtual object 10 from the flight state to the non-flight state, or switching a state of the virtual object 10 from the non-flight state to the flight state, or switching a state of the virtual object 10 from the grounded state to the flight state, or switching a state of the virtual object 10 from the flight state to the grounded state, but is not limited thereto. This is not specifically limited in the embodiments of this disclosure.

In some embodiments, when the current movement state of the virtual object 10 is the flight state, as shown in part (b) in FIG. 1, the computer device displays the dodge sub-control 20 and a flight sub-control 30 in the action control in response to the virtual object 10 being in the flight state.

The flight sub-control 30 is configured to control the virtual object 10 to perform a flight action in the air. In some embodiments, the flight sub-control 30 includes an upward flight sub-control and a downward flight sub-control. The upward flight sub-control is configured to control the virtual object 10 to fly upward, and the downward flight sub-control is configured to control the virtual object 10 to fly downward.

In some embodiments, a manner of the flight action of the virtual object 10 in the air includes at least one of the following, but is not limited thereto. Upward flight is used as an example, and downward flight is described in the same way.
Based on a trigger operation on the upward flight sub-control, the virtual object 10 flies upward at a constant speed for fixed duration. For example, after each trigger operation, the virtual object 10 flies upward at a speed of 5 m/s for 3 seconds.
Based on a trigger operation on the upward flight sub-control, the virtual object 10 flies upward and accelerates. For example, after each trigger operation, the virtual object 10 flies upward at an acceleration of 5 m/s² for 3 seconds.
Based on a trigger operation on the upward flight sub-control, the virtual object 10 flies upward a fixed distance. For example, after each trigger operation, the virtual object 10 flies 5 meters upward.
Based on a trigger operation on the upward flight sub-control, the virtual object 10 flies upward and decelerates.

In some embodiments, the computer device controls, in response to a trigger manner based on the action control, the virtual object 10 to perform skills in different control functions. The trigger manner includes at least one of a tap operation, a long-press operation, a slide operation, a scroll operation, a double-tap operation, and a triple-tap operation, but is not limited thereto. This is not specifically limited in the embodiments of this disclosure.

For example, the computer device controls, in response to a tap operation based on the dodge sub-control 20, the virtual object 10 to dodge and teleport in the virtual environment. Dodging and teleporting refers to quickly moving to another position other than a current position. For example, before the dodge sub-control 20 is tapped, the virtual object 10 is displayed in a region A, and after the dodge sub-control 20 is tapped, the virtual object 10 is displayed in a region B. The region A and the region B are different regions.

For example, the computer device controls, in response to a long-press operation based on the dodge sub-control 20, the virtual object 10 to switch a movement state in the virtual environment. For example, when the virtual object 10 is in the grounded state, the computer device controls, in response to the long-press operation based on the dodge sub-control 20, the virtual object 10 to switch to the flight state, and the virtual object 10 flies upward from an original standing position and hovers in the air. When the virtual object 10 is in the flight state, the computer device controls, in response to the long-press operation based on the dodge sub-control 20, the virtual object 10 to switch to the grounded state, and the virtual object 10 lands on the ground from an original hovering position.

For example, the computer device controls, in response to an upward slide operation between the dodge sub-control 20 and the upward flight sub-control, the virtual object 10 to fly upward in the virtual environment. The computer device controls, in response to a downward slide operation between the dodge sub-control 20 and the downward flight sub-control, the virtual object 10 to fly downward in the virtual environment.

Compared with the virtual object 10 in the grounded state, the virtual object 10 in the flight state may have action directions at more angles. For example, the virtual object 10 in the grounded state can perform an action only on a two-dimensional plane on the ground, while the virtual object 10 in the flight state can perform an action in a three-dimensional space, and can not only move forward, backward, left, and right, but also move upward and downward.

In some embodiments, in a case that the current movement state of the virtual object is the solo state (the non-flight state), a sub-control controlling the virtual object 10 itself is displayed. In a case that the current movement state of the virtual object is the flight state, a sub-control controlling the virtual object 10 itself and a sub-control controlling the virtual object 10 to perform a flight-type action are displayed. For example, in a case that the current movement state is the solo state, the virtual object 10 in the solo state relies on the virtual object 10 itself for action.

In some embodiments, in a case that the current movement state of the virtual object is the auxiliary item loading state (the non-flight state), a sub-control controlling an auxiliary item is displayed. In a case that the current movement state of the virtual object is the flight state, a sub-control controlling an auxiliary item and a sub-control controlling the virtual object 10 to perform a flight-type action are displayed.

In some embodiments, in a case that the current movement state of the virtual object is the cooldown state (the non-flight state), a sub-control controlling the virtual object 10 to move at a constant speed is displayed. In a case that the current movement state of the virtual object is the flight state, a sub-control controlling the virtual object 10 to move at a constant speed and a sub-control controlling the virtual object to perform a flight-type action are displayed. For example, in the cooldown state, the virtual object 10 moves within a specific speed range, or the virtual object 10 moves at a constant speed. For example, the virtual object 10 chases by running with a maximum speed of 2 m/s.

In some embodiments, in a case that the current movement state of the virtual object is the berserk state (the non-flight state), a sub-control controlling the virtual object 10 to accelerate is displayed. In a case that the current movement state of the virtual object is the flight state, a sub-control controlling the virtual object 10 to accelerate and a sub-control controlling the virtual object to perform a flight-type action are displayed. For example, in the berserk state, the virtual object 10 moves within a speed range with no upper limit, or the virtual object constantly accelerates. For example, the virtual object 10 in the berserk state chases by running, with the speed of the virtual object 10 constantly increasing and having no upper limit.

In conclusion, in this disclosure, when the virtual object is in the flight state, an action control in a flight form is displayed; and when the virtual object is in the non-flight state, an action control in a non-flight form is displayed. In other words, in this disclosure, the action control in the flight form and the action control in the non-flight form are combined, so that different control functions are performed through different forms of one action control, thereby avoiding the need for an additional action control to control flight, reducing an area occupied by the controls on a user interface, facilitating user operation, and improving human-computer interaction efficiency.

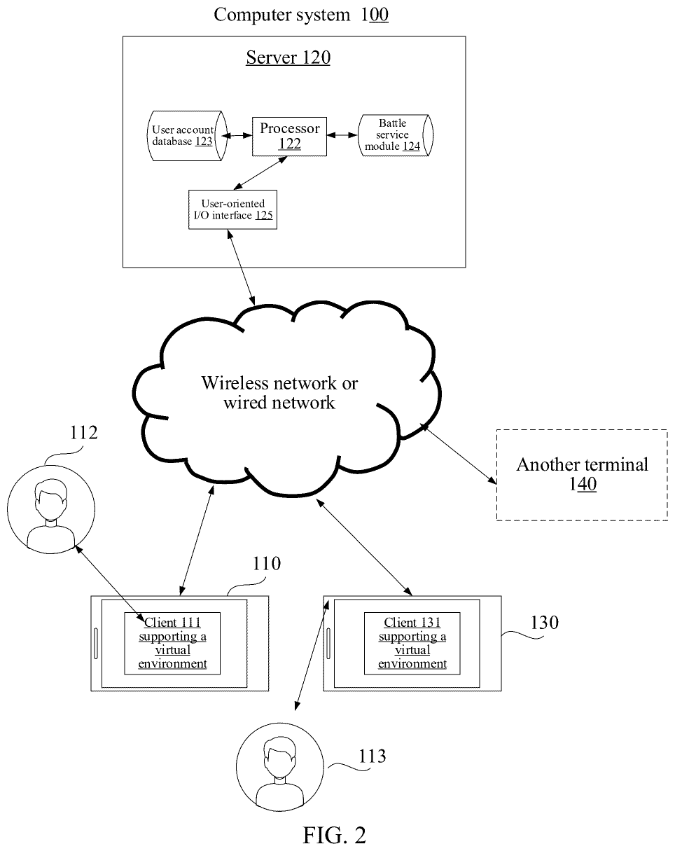

FIG. 2 is a structural block diagram of a computer system according to an embodiment of this disclosure. The computer system 100 includes a first terminal 110, a server 120, and a second terminal 130.

A client 111 supporting a virtual environment is installed and run on the first terminal 110, and the client 111 may be a multiplayer online battle program. When the first terminal 110 runs the client 111, a user interface of the client 111 is displayed on a screen of the first terminal 110. The client 111 may be any one of a battle royale shooting game, a virtual reality (VR) application, an augmented reality (AR) program, a three-dimensional map program, a virtual reality game, an augmented reality game, a first-person shooting (FPS) game, a third-person shooting (TPS) game, a multiplayer online battle arena (MOBA) game, and a simulation game (SLG). In this embodiment, an example in which the client 111 is a MOBA game is used for description. The first terminal 110 is a terminal used by a first user 112. The first user 112 uses the first terminal 110 to control a first virtual object located in the virtual environment to perform an action or operate a virtual item owned by a second virtual object. The first virtual object may be referred to as a virtual object controlled by the first user 112. The first user 112 may perform an operation such as assembling, disassembling, or uninstalling a virtual item owned by the first virtual object. This is not limited in this disclosure. In an example, the first virtual object is a virtual character, such as a simulated human character or an animated character.

A client 131 supporting a virtual environment is installed and run on the second terminal 130, and the client 131 may be a multiplayer online battle program. When the second terminal 130 runs the client 131, a user interface of the client 131 is displayed on a screen of the second terminal 130. The client may be any one of an escape shooting game, a VR application, an AR program, a three-dimensional map program, a virtual reality game, an augmented reality game, an FPS game, a TPS game, a MOBA game, and an SLG. In this embodiment, an example in which a client is a MOBA game is used for description. The second terminal 130 is a terminal used by a second user 113. The second user 113 uses the second terminal 130 to control a second virtual object located in the virtual environment to perform an action and operate a virtual item owned by the second virtual object. The second virtual object may be referred to as a virtual object controlled by the second user 113. In an example, the second virtual object is a virtual character, such as a simulated human character or an animated character.

In some embodiments, the first virtual object and the second virtual object are located in the same virtual environment. In some embodiments, the first virtual object and the second virtual object may belong to the same camp, the same team, or the same organization, and have a friend relationship with each other or have a temporary communication permission. In some embodiments, the first virtual object and the second virtual object may belong to different camps, different teams, or different organizations, or have a hostile relationship with each other.

In some embodiments, the client installed on the first terminal 110 is the same as the client installed on the second terminal 130, or the clients installed on the two terminals are the same type of clients of different operating system platforms (Android system or iOS system). The first terminal 110 may generally refer to one of a plurality of terminals, and the second terminal 130 may generally refer to another one of the plurality of terminals. In this embodiment, the first terminal 110 and the second terminal 130 are merely used as an example for description. The first terminal 110 and the second terminal 130 are of the same device type or of different device types. The device type includes at least one of a smartphone, a tablet computer, an e-book reader, a moving picture experts group audio layer III (MP3) player, a moving picture experts group audio layer IV (MP4) player, a laptop, and a desktop computer.

FIG. 2 shows only two terminals. However, a plurality of other terminals 140 may access the server 120 in different embodiments. In some embodiments, there are one or more terminals 140 corresponding to a developer. A development and editing platform for the client supporting a virtual environment is installed on the terminal 140. The developer may edit and update the client on the terminal 140 and transmit an updated client installation package to the server 120 through a wired or wireless network. The first terminal 110 and the second terminal 130 may download the client installation package from the server 120 to update the client.

The first terminal 110, the second terminal 130, and the another terminal 140 are connected to the server 120 through a wireless network or a wired network.

The server 120 includes at least one of one server, a plurality of servers, a cloud computing platform, and a virtualization center. The server 120 is configured to provide a backend service for a client supporting a virtual environment. In some embodiments, the server 120 is responsible for primary computing work, and the terminal is responsible for secondary computing work; or the server 120 is responsible for secondary computing work, and the terminal is responsible for primary computing work; or a distributed computing architecture is used between the server 120 and the terminal to perform collaborative computing.

In an example, the server 120 includes a processor 122, a user account database 123, a battle service module 124, and a user-oriented input/output interface (I/O interface) 125. The processor 122 is configured to load instructions stored in the server 120, and process data in the user account database 123 and the battle service module 124. The user account database 123 is configured to store data of user accounts used by the first terminal 110, the second terminal 130, and the another terminal 140, for example, avatars of the user accounts, nicknames of the user accounts, combat power indexes of the user accounts, and service zones of the user accounts. The battle service module 124 is configured to provide a plurality of battle rooms for the users to perform a battle, for example, a 1V1 battle, a 3V3 battle, or a 5V5 battle. The user-oriented I/O interface 125 is configured to establish communication between the first terminal 110 and/or the second terminal 130 through a wireless network or a wired network for data exchange.

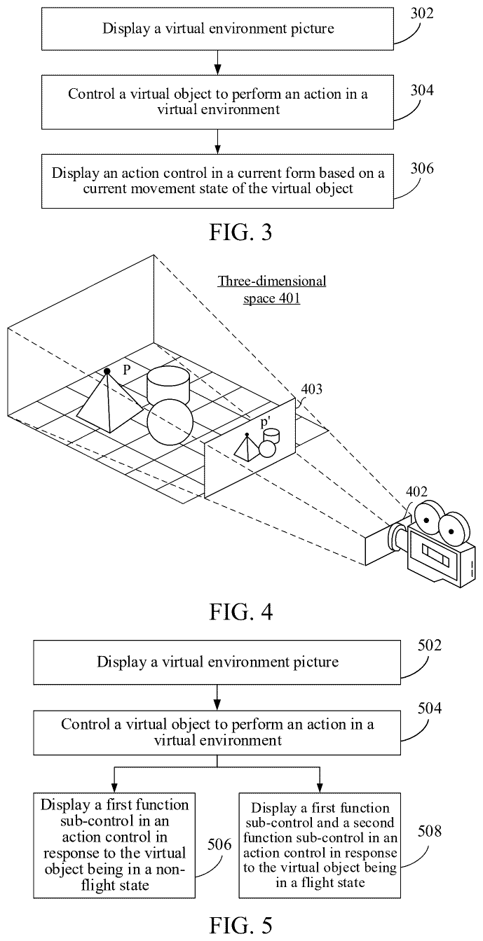

FIG. 3 is a flowchart of a virtual object control method according to an embodiment of this disclosure. The method may be performed by a computer device. The computer device includes a terminal or a client on a terminal. The method includes the following operations.

### Operation 302: Display a Virtual Environment Picture.

In an example, a virtual scene of a virtual environment is output for display. The virtual scene includes a virtual object located in the virtual environment.

The virtual environment picture is configured for displaying a picture obtained by observing a virtual environment. The virtual environment picture includes a virtual object located in the virtual environment. In some embodiments, the virtual environment picture is the picture obtained by observing the virtual environment. Model information of a three-dimensional virtual model of the virtual environment is obtained, and the three-dimensional virtual model is rendered as a screenshot, to form an imaging plane of the virtual environment picture.

The virtual environment is an environment in which the virtual object is located in a virtual world during running of an application in the terminal. In this embodiment of this disclosure, the virtual environment is observed through a camera model in the virtual world.

### Operation 304: Control the Virtual Object to Perform an Action in the Virtual Environment.

The virtual object refers to a virtual object controlled by an account logged into on the terminal.

An object (which may also be referred to as a user) controls, through an operation control, the virtual object to perform an action in the virtual environment. The object may control, by pressing a button in one or more operation controls, the virtual object to perform an action. The action includes, but is not limited to at least one of adjusting body posture, walking, running, jumping, riding, driving, aiming, picking up, and using a throwable item. This is not limited in the embodiments of this disclosure.

In some embodiments, the object may control, by pressing the button in the one or more operation controls, the virtual object to cast a skill or use an item. The object may alternatively control the virtual object through a signal generated by long pressing, tapping, double-tapping and/or sliding on a touchscreen.

In some embodiments, a manner for controlling the virtual object to perform an action includes: the object controls, through a virtual joystick on a terminal interface, the virtual object to perform an action; the object controls, through an external device (such as a game controller, VR glasses, or a VR headset), the virtual object to perform an action; the object controls, through audio, the virtual object to perform an action; and the object controls, through a motion sensing operation, the virtual object to perform an action. The manner for controlling the virtual object to perform an action is not specifically limited in this disclosure.

### Operation 306: Display an Action Control in a Current Form Based on a Current Movement State of the Virtual Object.

In an example, an action control element in one of a plurality of forms is output for display based on a current movement state of the virtual object. The action control element is displayed in a first form of the plurality of forms based on the current movement state being a non-flight state. The action control element is displayed in a second form of the plurality of forms based on the current movement state being a flight state.

The current movement state is a flight state or a non-flight state, the current form is corresponding to the current movement state, and the action control in the current form is configured to implement a control function in the current movement state. The flight state refers to a state in which the virtual object hovers in the air.

The action control includes at least two sub-controls. The action control in each form displays at least one of the at least two sub-controls. Quantities of sub-controls displayed by action controls in different forms are different. Each sub-control is configured to implement at least one control function.

The action control is obtained through combination of sub-controls providing different control functions, or the action control refers to a control that can provide at least two control functions. For example, the action control can not only control the virtual object to dodge and teleport, but also control the virtual object to fly. A movement state refers to a state related to the virtual object, or a position state of the virtual object in the virtual environment, or a motion state of the virtual object in the virtual environment.

In some embodiments, the non-flight state includes at least one of a grounded state, a solo state, an auxiliary item loading state, a cooldown state, and a berserk state, but is not limited thereto. This is not specifically limited in the embodiments of this disclosure.

The grounded state refers to a state in which the virtual object is located on the ground in the virtual environment, or the grounded state means that the virtual object has support in the virtual environment. In an example, when the virtual object is in the grounded state, the virtual environment picture displays only a dodge sub-control in the action control, and the virtual object is controlled, through the dodge sub-control, to perform a dodge action; or when the virtual object is in the flight state, the virtual environment picture displays a dodge sub-control and a flight sub-control in the action control, the virtual object is controlled, through the dodge sub-control, to perform a dodge action, and the virtual object is controlled, through the flight sub-control, to fly in the air.

In conclusion, when the virtual object is in the flight state, an action control in a flight form is displayed; and when the virtual object is in the non-flight state, an action control in a non-flight form is displayed. In other words, in this disclosure, the action control in the flight form and the action control in the non-flight form are combined, so that different control functions are performed through different forms of one action control, thereby avoiding the need for an additional action control to control flight, reducing an area occupied by the controls on a user interface, facilitating user operation, and improving human-computer interaction efficiency.

FIG. 4 is a schematic diagram of a transformation process from a three-dimensional space into a two-dimensional image according to an embodiment of this disclosure. With reference to FIG. 4, a process of mapping a feature point P in a three-dimensional space 401 to a feature point p′ in an imaging plane 403 (an image coordinate system, or referred to as a pixel coordinate system) is shown. Coordinates of the feature point P in the three-dimensional space 401 are in a three-dimensional form, and coordinates of the feature point p′ in the imaging plane 403 are in a two-dimensional form. The three-dimensional space 401 is a three-dimensional space corresponding to a virtual environment. A camera plane 402 is determined by a pose of a camera model. The camera plane 402 is a plane perpendicular to a photographing direction of the camera model. The imaging plane 403 and the camera plane 402 are parallel to each other. The imaging plane 403 is a plane of the virtual environment within a field of view during imaging by the camera model when the virtual environment is observed.

FIG. 5 is a flowchart of a virtual object control method according to an embodiment of this disclosure. The method may be performed by a computer device. The computer device includes a terminal. The method includes the following operations.

### Operation 502: Display a Virtual Environment Picture.

The virtual environment picture is configured for displaying a picture obtained by observing a virtual environment.

The virtual environment picture includes a virtual object located in the virtual environment.

### Operation 504: Control the Virtual Object to Perform an Action in the Virtual Environment.

The virtual object refers to a virtual object controlled by an account logged into on the terminal.

An object controls, through an operation control, the virtual object to perform an action in the virtual environment. The object may control, by pressing a button in one or more operation controls, the virtual object to perform an action. The action includes, but is not limited to at least one of adjusting body posture, walking, running, jumping, riding, driving, aiming, picking up, and using a throwable item. This is not limited in the embodiments of this disclosure.

Operation 506: Display a First Function Sub-Control in an Action Control in Response to the Virtual Object being in a Non-Flight State.

The first function sub-control is configured to control the virtual object to perform a basic-type action. In some embodiments, in a case that the non-flight state is a grounded state, the basic-type action includes at least one of a dodge action, a somersault action, a high jump action, and a backflip action, but is not limited thereto. This is not limited in the embodiments of this disclosure. In a case that the non-flight state is a solo state, the basic-type action refers to an action performed depending on the virtual object itself, for example, a running action of the virtual object. In a case that the non-flight state is a cooldown state, the basic-type action refers to an action controlling the virtual object to move within a specific speed range, or an action controlling the virtual object to move at a constant speed. For example, the virtual object chases by running with a maximum speed of 2 m/s.

The action control is obtained through combination of sub-controls providing different control functions, or the action control refers to a control that can provide at least two control functions. For example, the action control can not only control the virtual object to dodge and teleport, but also control the virtual object to fly.

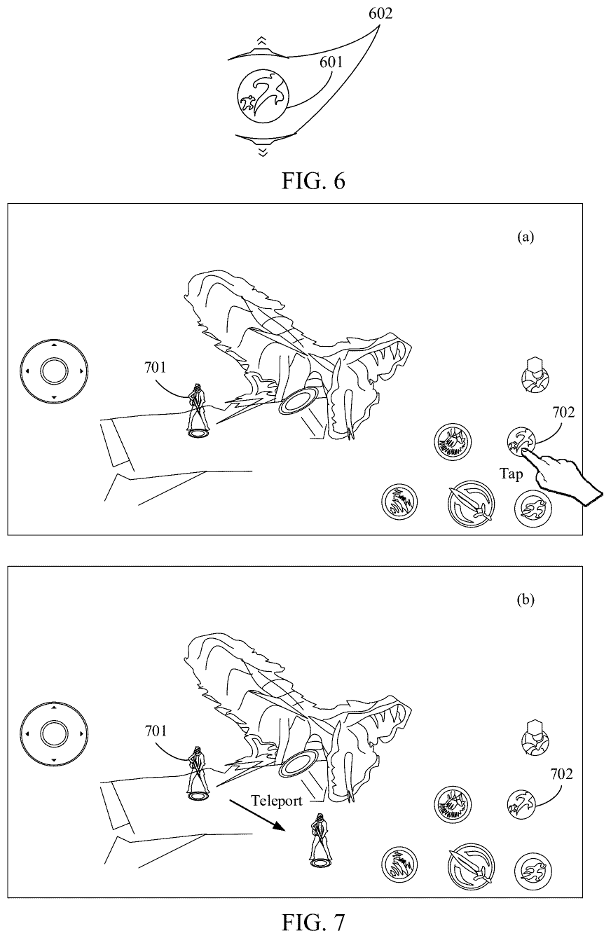

In an example, FIG. 6 is a schematic diagram of an action control. The action control includes a first function sub-control 601 and a second function sub-control 602. The first function sub-control 601 and the second function sub-control 602 each perform a different skill. For example, the first function sub-control 601 is a dodge sub-control, and the second function sub-control 602 is a flight sub-control. The virtual object is controlled through the dodge sub-control to perform a dodge action, and the virtual object is controlled through the flight sub-control to perform a flight action. In this embodiment of this disclosure, a sub-control controlling a dodge function and a sub-control controlling a flight function are combined, to achieve a flight effect of the virtual object without additional addition of a control controlling the flight function. In some embodiments, the first function sub-control 601 and the second function sub-control 602 in the action control are displayed according to a state of the virtual object. For example, in a case that the virtual object is in the grounded state, only the first function sub-control 601 in the action control is displayed, that is, only the dodge sub-control is displayed. In a case that the virtual object is in a flight state, both the first function sub-control 601 and the second function sub-control 602 in the action control are displayed, that is, both the dodge sub-control and the flight sub-control are displayed.

The non-flight state being the grounded state is used as an example. The grounded state refers to a state in which the virtual object is located on the ground in the virtual environment, or the grounded state means that the virtual object has support in the virtual environment.

In an example, the computer device displays the dodge sub-control in the action control in response to the virtual object being in the grounded state. In some embodiments, the grounded state includes: the virtual object standing on the ground, the virtual object standing on a rock, the virtual object running on the grass, and the virtual object crawling on the grass, but is not limited thereto. This is not specifically limited in the embodiments of this disclosure.

The dodge sub-control is configured to control the virtual object to perform a dodge action or perform state switching of the virtual object.

The state switching refers to switching a state of the virtual object from the flight state to the non-flight state, or switching a state of the virtual object from the non-flight state to the flight state, or switching a state of the virtual object from the grounded state to the flight state, or switching a state of the virtual object from the flight state to the grounded state, but is not limited thereto. This is not specifically limited in the embodiments of this disclosure.

In some embodiments, in response to a first trigger manner based on the first function sub-control in the action control, the virtual object is controlled to perform a skill corresponding to the first function sub-control. In some embodiments, the first trigger manner includes at least one of a tap operation, a long-press operation, a slide operation, a scroll operation, a double-tap operation, and a triple-tap operation, but is not limited thereto. This is not specifically limited in the embodiments of this disclosure. In an example, the computer device controls, in response to a tap operation based on the dodge sub-control, the virtual object to dodge and teleport in the virtual environment.

Dodging and teleporting refers to quickly moving to another position other than a current position. For example, before the dodge sub-control is tapped, the virtual object is displayed in a region A, and after the dodge sub-control is tapped, the virtual object is displayed in a region B. The region A and the region B are different regions. In some embodiments, a dodge and teleportation distance is fixed. For example, each time the dodge sub-control is tapped, the virtual object dodges and teleports 10 meters.

In some embodiments, a manner for determining a dodge and teleportation direction is as follows:
In a case that the dodge and teleportation direction is not determined through a joystick operation control, the dodge and teleportation direction is a direction corresponding to a forward-facing orientation of the virtual object, that is, the dodging and teleporting is performed forward.
In a case that the dodge and teleportation direction is not determined through a joystick operation control, the dodge and teleportation direction is opposite to a direction corresponding to a forward-facing orientation of the virtual object, that is, the dodging and teleporting is performed backward.
In a case that the dodge and teleportation direction is not determined through a joystick operation control, the dodge and teleportation direction is at a specific angle relative to a facing orientation of the virtual object.
In a case that the dodge and teleportation direction is determined through a joystick operation control, the dodge and teleportation direction is a direction determined through the joystick operation control. In response the dodge sub-control receiving a short-press operation, the virtual object is controlled to perform a dodge action in a direction corresponding to the joystick operation control.

In an example, FIG. 7 is a schematic diagram of triggering an action control. As shown in (a) in FIG. 7, a computer device displays a virtual environment picture. The virtual environment picture includes a virtual object 701 located in a virtual environment. In a case that the virtual object 701 is in a grounded state, only a dodge sub-control 702 in the action control is displayed. As shown in (b) in FIG. 7, by tapping the dodge sub-control 702, the virtual object 701 performs a dodge action in the virtual environment. In some embodiments, a direction of the dodge action is a face orientation of the virtual object 701, or a direction opposite to a face orientation of the virtual object 701.

In an embodiment, the current movement state of the virtual object is switched in response to the action control receiving a trigger operation. The current movement state of the virtual object is switched in response to the first function sub-control receiving a long-press operation. For example, in a case that the virtual object is in the flight state, in response to the first function sub-control receiving the long-press operation, the virtual object is controlled to perform a landing action; or in a case that the virtual object is in the non-flight state, in response to the first function sub-control receiving the long-press operation, the virtual object is controlled to perform a takeoff action.

For example, the computer device controls, in response to a long-press operation based on the dodge sub-control, the virtual object to switch a movement state in the virtual environment.

For example, when the virtual object is in the grounded state, the computer device controls, in response to the long-press operation based on the dodge sub-control, the virtual object to switch the grounded state to the flight state, and the virtual object flies upward from an original standing position and hovers in the air. When the virtual object is in the flight state, the computer device controls, in response to the long-press operation based on the dodge sub-control, the virtual object to switch the flight state to the grounded state, and the virtual object lands on the ground from an original hovering position.

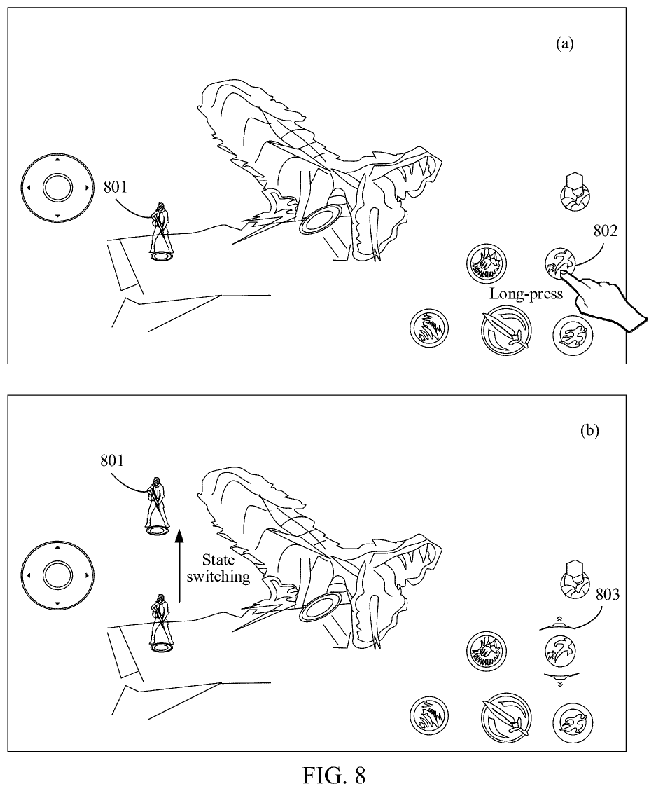

In an example, FIG. 8 is a schematic diagram of triggering an action control. As shown in (a) in FIG. 8, a computer device displays a virtual environment picture. The virtual environment picture includes a virtual object 801 located in a virtual environment. In a case that the virtual object 801 is in a grounded state, only a dodge sub-control 802 in the action control is displayed, and by long-pressing the dodge sub-control 802, the virtual object 801 switches a movement state in the virtual environment. As shown in (b) in FIG. 8, after the movement state of the virtual object 801 is switched, the virtual object 801 is in a flight state, and the virtual object 801 hovers in the air. Both the dodge sub-control 802 and a flight sub-control 803 in the action control are displayed, and by triggering the flight sub-control 803, the virtual object 801 may be controlled to perform a flight action.

Operation 508: Display the First Function Sub-Control and the Second Function Sub-Control in the Action Control in Response to the Virtual Object being in a Flight State.

The second function sub-control is configured to control the virtual object to perform a flight-type action in the flight state. The flight state refers to a state in which the virtual object hovers in the air. In an example, the computer device displays both a dodge sub-control (the first function sub-control) and a flight sub-control (the second function sub-control) in the action control in response to the virtual object being in the flight state.

The flight sub-control is configured to control the virtual object to perform a flight action in the air. In some embodiments, the flight sub-control includes an upward flight sub-control and a downward flight sub-control. The upward flight sub-control is configured to control the virtual object to fly upward, and the downward flight sub-control is configured to control the virtual object to fly downward.

In some embodiments, the computer device controls, in response to a second trigger manner based on the second function sub-control in the action control, the virtual object to perform a skill corresponding to the second function sub-control. In some embodiments, the second trigger operation includes at least one of a tap operation, a long-press operation, a slide operation, a scroll operation, a double-tap operation, and a triple-tap operation, but is not limited thereto. This is not specifically limited in the embodiments of this disclosure.

In some embodiments, the computer device controls, in response to a trigger operation based on the upward flight sub-control, the virtual object to fly upward in the virtual environment; or the computer device controls, in response to a trigger operation based on the downward flight sub-control, the virtual object to fly downward in the virtual environment.

In an embodiment, in response to the upward flight sub-control receiving a tap operation, the virtual object is controlled to fly upward in the virtual environment; or in response to the downward flight sub-control receiving a tap operation, the virtual object is controlled to fly downward in the virtual environment.

In another embodiment, in response to a slide operation based on the upward flight sub-control, the virtual object is controlled to fly upward in the virtual environment; or in response to a slide operation based on the downward flight sub-control, the virtual object is controlled to fly downward in the virtual environment.

In some embodiments, in response to the upward flight sub-control receiving the slide operation, the virtual object is controlled to fly upward in the virtual environment. The upward flight sub-control serves as a starting point of the slide operation, and the slide operation is an operation in which a slide distance exceeds a slide distance threshold. In response to the slide operation based on the downward flight sub-control, the virtual object is controlled to fly downward in the virtual environment. The downward flight sub-control serves as a starting point of the slide operation, and the slide operation is an operation in which a slide distance exceeds the slide distance threshold.

In some embodiments, the upward flight sub-control is located above the first function sub-control, and the downward flight sub-control is located below the first function sub-control. In response to receiving an upward slide operation between the first function sub-control and the upward flight sub-control, the virtual object is controlled to fly upward in the virtual environment. The upward slide operation is a slide operation starting from the first function sub-control. In response to receiving a downward slide operation between the first function sub-control and the downward flight sub-control, the virtual object is controlled to fly downward in the virtual environment. The downward slide operation is a slide operation starting from the first function sub-control.

In an example, the upward flight sub-control is represented as an upper edge indicator pattern, and the upward slide operation is a slide operation starting from the first function sub-control toward a position of the upper edge indicator pattern with a slide distance exceeding the slide distance threshold. The downward flight sub-control is represented as a lower edge indicator pattern, and the downward slide operation is a slide operation starting from the first function sub-control toward a position of the lower edge indicator pattern with a slide distance exceeding the slide distance threshold.

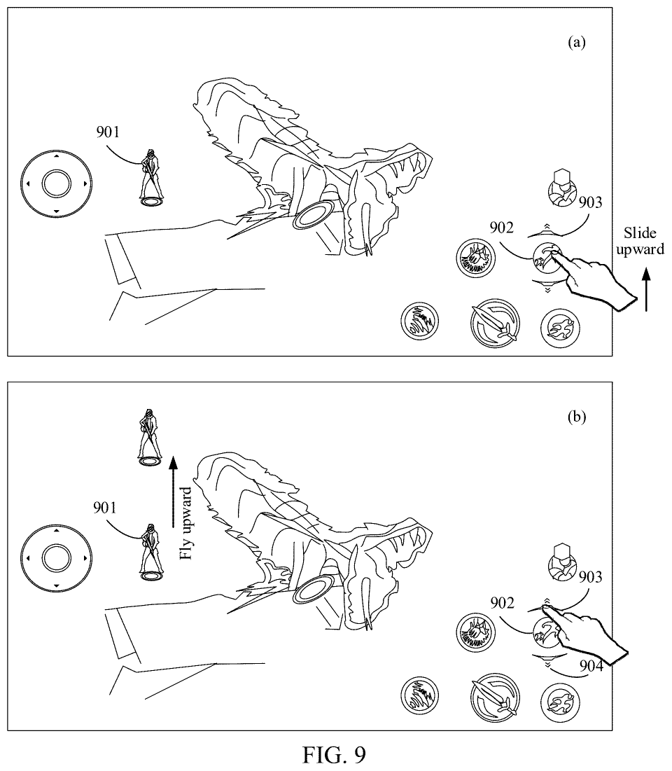

In an example, FIG. 9 is a schematic diagram of triggering an action control. As shown in (a) in FIG. 9, a computer device displays a virtual environment picture. The virtual environment picture includes a virtual object 901 located in a virtual environment. The virtual object 901 is in a flight state, and both a dodge sub-control 902 and a flight sub-control in the action control are displayed. The flight sub-control includes an upward flight sub-control 903 and a downward flight sub-control 904. An upward slide operation is performed in a direction between the dodge sub-control 902 and the upward flight sub-control 903. As shown in (b) in FIG. 9, the virtual object 901 is controlled to fly upward in the virtual environment.

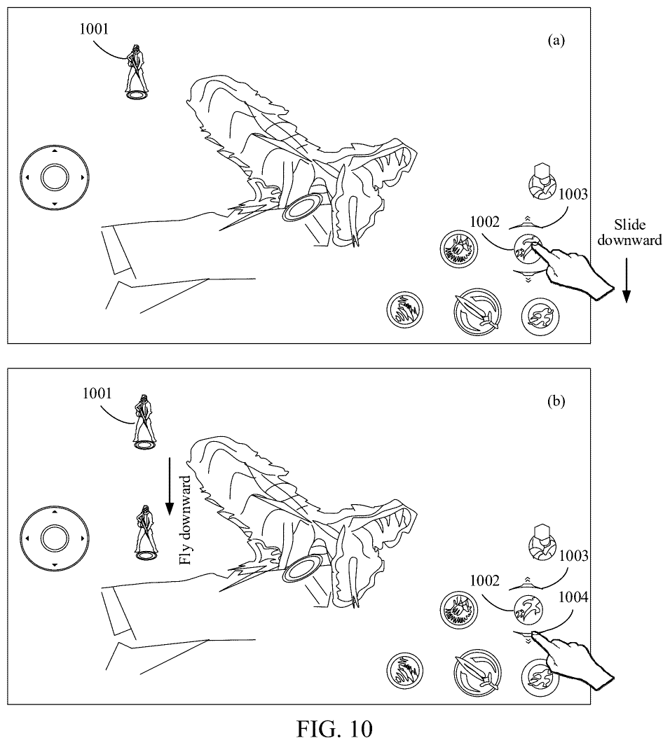

In an example, FIG. 10 is a schematic diagram of triggering an action control. As shown in (a) in FIG. 10, a computer device displays a virtual environment picture. The virtual environment picture includes a virtual object 1001 located in a virtual environment. The virtual object 1001 is in a flight state, and both a dodge sub-control 1002 and a flight sub-control in the action control are displayed. The flight sub-control includes an upward flight sub-control 1003 and a downward flight sub-control 1004. A downward slide operation is performed in a direction between the dodge sub-control 1002 and the downward flight sub-control 1004. As shown in (b) in FIG. 10, the virtual object 1001 is controlled to fly downward in the virtual environment.

In conclusion, in the method provided in this disclosure, the first function sub-control in the action control is displayed when the virtual object is in the non-flight state; or both the first function sub-control and the second function sub-control in the action control are displayed when the virtual object is in the flight state. Different sub-controls are displayed through different movement forms, thereby simplifying the operation, further reducing an area occupied by the controls on the user interface, reducing an operation requirement for the user, and improving human-computer interaction efficiency.

In the method provided in the embodiments, for the same action control, through different trigger manners such as the tap operation, the long-press operation, and the slide operation, the virtual object is controlled to perform skills in different control functions, thereby reducing the area occupied by the controls on the user interface, reducing an operation requirement for the user, and improving human-computer interaction efficiency.

In some embodiments, the virtual environment picture further displays a joystick operation control. In response to a combined trigger manner based on the joystick operation control and the action control, the virtual object is controlled to perform the skills in the different control functions in a direction corresponding to the joystick operation control.

In some embodiments, the computer device controls, in response to a combined trigger manner based on the joystick operation control and the dodge sub-control, the virtual object to dodge and teleport in a direction corresponding to the joystick operation control. The joystick operation control is configured to control a horizontal direction of dodging.

In some embodiments, the computer device controls, in response to a combined trigger manner based on the joystick operation control and the flight sub-control, the virtual object to perform a flight action in a direction corresponding to the joystick operation control. The joystick operation control is configured to control a horizontal direction of a flight, and the flight sub-control is configured to control a vertical direction of the flight.

Specifically, in response to receiving the upward slide operation between the first function sub-control and the upward flight sub-control and a joystick operation on the joystick operation control, the virtual object is controlled to fly obliquely upward in a horizontal direction of the joystick operation in the virtual environment. In response to receiving the downward slide operation between the first function sub-control and the downward flight sub-control and a joystick operation on the joystick operation control, the virtual object is controlled to fly obliquely downward in a horizontal direction of the joystick operation in the virtual environment.

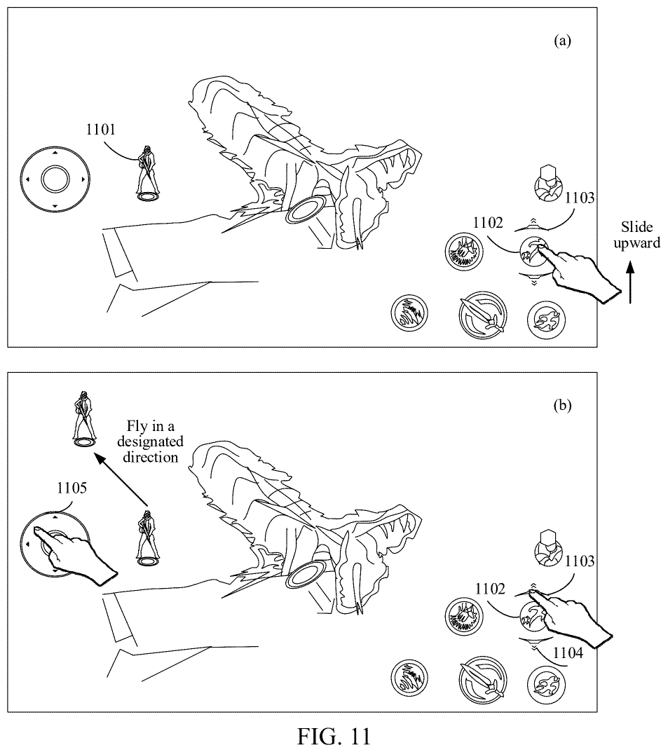

In an example, FIG. 11 is a schematic diagram of triggering an action control. As shown in (a) in FIG. 11, a computer device displays a virtual environment picture. The virtual environment picture includes a virtual object 1101 located in a virtual environment and a joystick operation control 1105. The virtual object 1101 is in a flight state, and both a dodge sub-control 1102 and a flight sub-control in the action control are displayed. The flight sub-control includes an upward flight sub-control 1103 and a downward flight sub-control 1104. An upward slide operation is performed in a direction between the dodge sub-control 1102 and the upward flight sub-control 1103. In addition, a horizontal flight direction of the virtual object 1101 is determined by controlling the joystick operation control 1105. For example, the direction determined through the joystick operation control 1105 is 45 degrees northwest. As shown in (b) in FIG. 11, the virtual object 1101 is controlled to fly upward in the virtual environment in a horizontal direction being the 45 degrees northwest.

In some embodiments, the computer device controls, in response to a combined trigger manner based on the joystick operation control and the action control, the virtual object to perform the skills in the different control functions in a coupled direction. The coupled direction refers to a combined direction of a direction corresponding to the joystick operation control and directions of the skills in the different control functions.

In some embodiments, the computer device controls, in response to a combined trigger manner based on the joystick operation control and the dodge sub-control, the virtual object to dodge and teleport in a first coupled direction. The first coupled direction refers to a combined direction of a direction corresponding to the joystick operation control and a dodge and teleportation direction corresponding to the dodge sub-control. For example, if the direction corresponding to the joystick operation control is westward, and the dodge and teleportation direction is northward, the first coupled direction is a northwest direction.

In some embodiments, the computer device controls, in response to a combined trigger manner based on the joystick operation control and the flight sub-control, the virtual object to perform a flight action in a second coupled direction. The second coupled direction refers to a combined direction of a direction corresponding to the joystick operation control and a flight direction corresponding to the flight sub-control. For example, if the direction corresponding to the joystick operation control is westward, and the flight direction corresponding to the flight sub-control is upward, the second coupled direction is a coupled direction that is horizontally westward and vertically upward in a three-dimensional space.

In conclusion, in the method provided in the embodiments, the combined trigger manner based on the joystick operation control and the action control allows the virtual object to have more diverse action manners and skill cast manners, thereby improving the human-computer interaction efficiency.

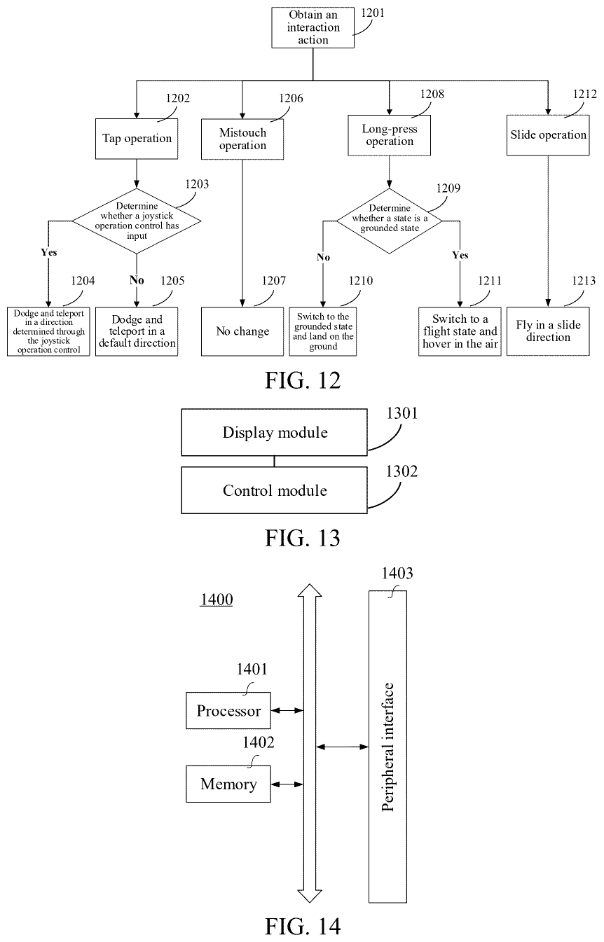

FIG. 12 is a flowchart of a virtual object control method according to an embodiment of this disclosure. The method may be performed by a computer device. The computer device includes a terminal. The method includes the following operations.

### Operation 1201: Obtain an Interaction Action.

The interaction action refers to a trigger manner in which a user interacts with a dodge sub-control on a user interface.

In some embodiments, the trigger manner includes at least one of a tap operation, a long-press operation, a slide operation, a scroll operation, a double-tap operation, and a triple-tap operation, but is not limited thereto. This is not specifically limited in the embodiments of this disclosure.

In an example, the computer device obtains a trigger manner between the user and the dodge sub-control on the user interface, and in a case that the interaction action is the tap operation, operation 1202 is performed. In a case that the interaction action is a mistouch operation, operation 1206 is performed. In a case that the interaction action is the long-press operation, operation 1208 is performed. In a case that the interaction action is the slide operation, operation 1212 is performed.

A manner in which the computer device obtains the interaction action is at least one of the following manners, but is not limited thereto.
When the user triggers the dodge sub-control, timing is started, and duration is denoted as A. When a finger is released, or after specific duration (for example, 1 second) is reached, the timing is ended, and the recording is reset.
When the user triggers the dodge sub-control, recording of a coordinate position of a finger is started, and a position offset span is denoted as B. When the finger is released, or after a specific position span is reached, recording of the offset span is ended, and the recording is reset.

For example, an absolute value of the offset span is 30 pixels. The 30 pixels are a distance from a default state of the dodge sub-control to a flight sub-control.

The computer device determines the interaction action based on the recorded duration A and/or the recorded position offset span B.

### Operation 1202: Tap Operation.

The tap operation means that a finger is pressed on a button/region on a screen and the finger is then quickly released.

The computer device obtains a parameter of a current interaction action. In a case that the duration A is less than 0.2 seconds, and a position offset |B| is less than 30 pixels, the current interaction action is determined as the tap operation.

In a case that the current interaction action is the tap operation, operation 1203 is performed.

### Operation 1203: Determine Whether a Joystick Operation Control has Input.

The joystick operation control is configured to control movement of the virtual object in a horizontal direction, including movement in each horizontal direction such as forward, backward, left, or right.

In an example, in a case that the current interaction action is the tap operation, whether the joystick operation control has input is determined. In a case that the joystick operation control has input, operation 1204 is performed. In a case that the joystick operation control has no input, operation 1205 is performed.

### Operation 1204: Dodge and Teleport in a Direction Determined Through the Joystick Operation Control.

In an example, in a case that the joystick operation control has input, a direction corresponding to the joystick operation control is determined, and the virtual object is controlled to dodge and teleport in the direction determined through the joystick operation control. For example, based on the direction determined through the joystick operation control, the virtual object is controlled to dodge and teleport 10 meters in the direction determined through the joystick operation control.

### Operation 1205: Dodge and Teleport in a Default Direction.

In an example, in a case that the joystick operation control has no input, the virtual object is controlled to dodge and teleport in the default direction. For example, the virtual object is controlled to dodge and teleport 10 meters in the default direction.

The default direction includes at least one of the following directions.
The dodge and teleportation direction is a direction corresponding to a forward-facing orientation of the virtual object, that is, the dodging and teleporting is performed forward.
The dodge and teleportation direction is opposite to a direction corresponding to a forward-facing orientation of the virtual object, that is, the dodging and teleporting is performed backward.

### Operation 1206: Mistouch Operation.

The computer device obtains a parameter of a current interaction action. In a case that the duration A is greater than or equal to 0.2 seconds and is less than or equal to 1 second, and the position offset |B| is less than 30 pixels, the current interaction action is determined as the mistouch operation.

In a case that the current interaction action is the mistouch operation, operation 1207 is performed.

### Operation 1207: No Change.

In a case that the current interaction action is the mistouch operation, the virtual environment picture displays no change.

### Operation 1208: Long-Press Operation.

The computer device obtains a parameter of a current interaction action. In a case that the duration A is equal to 1 second (timing is ended once 1 second is reached, and theoretically, it is not greater than 1 second), and the position offset |B| is less than 30 pixels, the current interaction action is determined as the long-press operation.

The long-press operation is configured for controlling the virtual object to switch a movement state in the virtual environment.

In a case that the interaction action is the long-press operation, operation 1209 is performed.

### Operation 1209: Determine Whether the State is a Grounded State.

In a case that the current interaction action is the long-press operation, the movement state of the virtual object is determined based on a flag bit of the virtual object.

The movement state refers to a state related to the virtual object, or a position state of the virtual object in the virtual environment, or a motion state of the virtual object in the virtual environment. In some embodiments, the movement state includes at least one of the grounded state and a flight state, but is not limited thereto. This is not specifically limited in the embodiments of this disclosure. The grounded state refers to a state in which the virtual object is located on the ground in the virtual environment, or the grounded state means that the virtual object has support in the virtual environment. The flight state refers to a state in which the virtual object hovers in the air.

The flag bit is a state identifier of the virtual object. The state identifier includes 0 and 1. 0 is the grounded state, and 1 is the flight state. When the state identifier of the virtual object is 0, the virtual object is in the grounded state, only a dodge sub-control in an action control is displayed, and does not support the slide operation. When the state identifier of the virtual object is 1, the virtual object is in the flight state, both a dodge sub-control and a flight sub-control button in an action control are displayed, and may support the slide operation.

In an example, in a case that the virtual object is not in the grounded state, operation 1210 is performed. In a case that the virtual object is in the grounded state, operation 1211 is performed.

### Operation 1210: Switch to the Grounded State and Land on the Ground.

In a case that the virtual object is not in the grounded state, that is, in a case that the virtual object is in the flight state, the movement state of the virtual object is switched to the grounded state and the virtual object lands on the ground (the altitude of the virtual object on the y axis is decreased to 0). In addition, the state identifier of the virtual object is switched from 1 to 0, and the display of the flight sub-control button in the action control is canceled.

### Operation 1211: Switch to the Flight State and Hover in the Air.

In a case that the virtual object is in the grounded state, the movement state of the virtual object is switched to the flight state and the virtual object hovers in the air (the altitude of the virtual object on the y axis is increased by 10 meters). In addition, the state identifier of the virtual object is switched from 0 to 1, and the display of the flight sub-control button in the action control is added.

### Operation 1212: Slide Operation.

The computer device obtains a parameter of a current interaction action. In a case that the position offset |B| is equal to 30 pixels (recording is ended after 30 pixels are reached, and theoretically, B is not greater than 30 pixels), the current interaction action is determined as the slide operation.

The slide operation is configured for controlling the virtual object to fly in the virtual environment.

In a case that the current interaction action is the slide operation, operation 1213 is performed.

### Operation 1213: Fly in a Slide Direction.

In an example, the computer device controls the virtual object to fly in the slide direction.

For example, in a case that a value of the position offset B is +30 pixels, the virtual object is controlled to fly 10 meters upward in the virtual environment. In a case that the value of the position offset B is −30 pixels, the virtual object is controlled to fly 10 meters downward in the virtual environment.

FIG. 13 is a schematic structural diagram of a virtual object control apparatus according to an embodiment of this disclosure. The apparatus may be implemented as an entire computer device or a part of the computer device by using software, hardware, or a combination thereof. The apparatus includes:
a display module 1301, configured to display a virtual environment picture, the virtual environment picture including a virtual object located in a virtual environment; and
a control module 1302, configured to control the virtual object to perform an action in the virtual environment,
the display module 1301 being configured to display an action control in a current form based on a current movement state of the virtual object, the current movement state being a flight state or a non-flight state, the current form being corresponding to the current movement state, and the action control in the current form being configured to implement a control function in the current movement state.

In some embodiments, the action control includes a first function sub-control and a second function sub-control; and the display module 1301 is further configured to: display the first function sub-control in the action control in response to the virtual object being in the non-flight state.

In some embodiments, the display module 1301 is further configured to: display the first function sub-control and the second function sub-control in the action control in response to the virtual object being in the flight state,
the first function sub-control being configured to control the virtual object to perform a basic-type action, and the second function sub-control being configured to control the virtual object to perform a flight-type action in the flight state.

In some embodiments, the display module 1301 is further configured to: display a dodge sub-control in the action control in response to the virtual object being in a grounded state,
the grounded state referring to a state in which the virtual object is located on the ground in the virtual environment, and the dodge sub-control in this case being configured to control the virtual object to perform a dodge action on the ground.

In some embodiments, the display module 1301 is further configured to: display a dodge sub-control and the second function sub-control in the action control in response to the virtual object being in the flight state,
the dodge sub-control in this case being configured to control the virtual object to perform a dodge action in the air.

In some embodiments, the control module 1302 is further configured to: switch the current movement state of the virtual object in response to the action control receiving a trigger operation.

In some embodiments, the control module 1302 is further configured to: switch the current movement state of the virtual object in response to the first function sub-control receiving a trigger operation.

In some embodiments, the control module 1302 is further configured to: switch the current movement state of the virtual object in response to the first function sub-control receiving a long-press operation.

In some embodiments, the control module 1302 is further configured to: in a case that the virtual object is in the flight state, control, in response to the first function sub-control receiving the long-press operation, the virtual object to perform a landing action.

In some embodiments, the control module 1302 is further configured to: in a case that the virtual object is in the non-flight state, control, in response to the first function sub-control receiving the long-press operation, the virtual object to perform a takeoff action.

In some embodiments, the control module 1302 is further configured to: control, in response to the first function sub-control receiving a short-press operation, the virtual object to perform the basic-type action.

In some embodiments, the virtual environment picture further displays a joystick operation control, and the first function sub-control is a dodge sub-control. The control module 1302 is further configured to: control, in response the dodge sub-control receiving the short-press operation, the virtual object to perform a dodge action in a direction corresponding to the joystick operation control.

In some embodiments, the second function sub-control includes an upward flight sub-control and a downward flight sub-control. The control module 1302 is further configured to: control, in response to a trigger operation based on the upward flight sub-control, the virtual object to fly upward in the virtual environment; or control, in response to a trigger operation based on the downward flight sub-control, the virtual object to fly downward in the virtual environment.

In some embodiments, the control module 1302 is further configured to: control, in response to a slide operation based on the upward flight sub-control, the virtual object to fly upward in the virtual environment.

In some embodiments, the control module 1302 is further configured to: control, in response to a slide operation based on the downward flight sub-control, the virtual object to fly downward in the virtual environment.

In some embodiments, the upward flight sub-control is located above the first function sub-control, and the downward flight sub-control is located below the first function sub-control. The control module 1302 is further configured to: control, in response to receiving an upward slide operation between the first function sub-control and the upward flight sub-control, the virtual object to fly upward in the virtual environment, the upward slide operation being a slide operation starting from the first function sub-control.

In some embodiments, the upward flight sub-control is located above the first function sub-control, and the downward flight sub-control is located below the first function sub-control. The control module 1302 is further configured to: control, in response to receiving a downward slide operation between the first function sub-control and the downward flight sub-control, the virtual object to fly downward in the virtual environment, the downward slide operation being a slide operation starting from the first function sub-control.

In some embodiments, the virtual environment picture further displays a joystick operation control. The control module 1302 is further configured to: control, in response to receiving the upward slide operation between the first function sub-control and the upward flight sub-control and a joystick operation on the joystick operation control, the virtual object to fly obliquely upward in a horizontal direction of the joystick operation in the virtual environment.

In some embodiments, the virtual environment picture further displays a joystick operation control. The control module 1302 is further configured to: control, in response to receiving the downward slide operation between the first function sub-control and the downward flight sub-control and a joystick operation on the joystick operation control, the virtual object to fly obliquely downward in a horizontal direction of the joystick operation in the virtual environment.

In some embodiments, the upward flight sub-control is represented as an upper edge indicator pattern, and the upward slide operation is a slide operation starting from the first function sub-control toward a position of the upper edge indicator pattern with a slide distance exceeding a slide distance threshold.

In some embodiments, the downward flight sub-control is represented as a lower edge indicator pattern, and the downward slide operation is a slide operation starting from the first function sub-control toward a position of the lower edge indicator pattern with a slide distance exceeding the slide distance threshold.

In conclusion, when the virtual object is in the flight state, an action control in a flight form is displayed; and when the virtual object is in the non-flight state, an action control in a non-flight form is displayed. In other words, in this disclosure, the action control in the flight form and the action control in the non-flight form are combined, so that different control functions are performed through different forms of one action control, thereby avoiding the need for an additional action control to control flight, reducing an area occupied by the controls on a user interface, facilitating user operation, and improving human-computer interaction efficiency.

FIG. 14 is a structural block diagram of a computer device 1400 according to an embodiment of this disclosure. The computer device 1400 may be a portable mobile terminal, such as a smartphone, a tablet computer, a moving picture experts group audio layer III (MP3) player, or a moving picture experts group audio layer (MP4) player. The computer device 1400 may be further referred to as another name such as user equipment or a portable terminal.

Generally, the computer device 1400 includes a processor 1401 and a memory 1402.

The processor 1401 is an example of processing circuitry and may include one or more processing cores, and may be, for example, a 4-core processor or an 8-core processor. The processor 1401 may be implemented by using at least one hardware form of a digital signal processor (DSP), a field programmable gate array (FPGA), and a programmable logic array (PLA). The processor 1401 may alternatively include a main processor and a coprocessor. The main processor is configured to process data in an active state, and is also referred to as a central processing unit (CPU); and the coprocessor is a low-power processor configured to process data in a standby state. In some embodiments, the processor 1401 may be integrated with a graphics processing unit (GPU). The GPU is configured to be responsible for rendering and drawing content that a display needs to display. In some embodiments, the processor 1401 may further include an artificial Intelligence (AI) processor. The AI processor is configured to process a computing operation related to machine learning.

The memory 1402 may include one or more computer-readable storage media. The computer-readable storage medium may be tangible or non-transitory. The memory 1402 may further include a high-speed random access memory and a non-volatile memory, for example, one or more disk storage devices or flash storage devices. In some embodiments, the non-transitory computer-readable storage medium in the memory 1402 is configured to store at least one instruction. The at least one instruction is executed by the processor 1401 to perform the virtual object control method provided in the embodiments of this disclosure.

In some embodiments, the computer device 1400 further includes a peripheral interface 1403 and at least one peripheral. Specifically, the peripheral device includes: at least one of a radio frequency circuit, a touch display screen, a camera component, an audio circuit, and a power supply.

A person skilled in the art may understand that the structure shown in FIG. 14 does not constitute any limitation on the computer device 1400, and the computer device may include more components or fewer components than those shown in the figure, or some components may be combined, or a different component deployment may be used.

An embodiment of this disclosure further provides a computer device, including a processor and a memory, the memory having at least one program stored therein, the at least one program being loaded and executed by the processor to implement the virtual object control method provided in the foregoing method embodiments.

An embodiment of this disclosure further provides a computer-readable storage medium, such as a non-transitory computer-readable storage medium, having at least one computer program stored therein, the at least one computer program being loaded and executed by a processor to implement the virtual object control method provided in the foregoing method embodiments.

An embodiment of this disclosure further provides a computer program product, including a computer program, the computer program being stored in a computer-readable storage medium; and the computer program being read from the computer-readable storage medium and executed by a processor of a computer device, to cause the computer device to perform the virtual object control method provided in the foregoing method embodiments.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

What is claimed is:

1. A virtual object control method, comprising:
outputting for display a virtual scene of a virtual environment, the virtual scene including a virtual object located in the virtual environment;
controlling the virtual object to perform an action in the virtual environment; and
outputting for display an action control element in one of a plurality of forms based on a current movement state of the virtual object, wherein
the action control element is displayed in a first form of the plurality of forms based on the current movement state being a non-flight state, and
the action control element is displayed in a second form of the plurality of forms based on the current movement state being a flight state.

2. The method according to claim 1, wherein
the first form of the action control element includes a first function sub-control element; and
the second form of the action control element includes the first function sub-control element and a second function sub-control element.

3. The method according to claim 2, wherein
the non-flight state is a state in which the virtual object is located on a ground in the virtual environment; and
the first function sub-control element is configured to control the virtual object to perform a dodge action on the ground when the virtual object is in the non-flight state.

4. The method according to claim 2, wherein
the first function sub-control element is configured to control the virtual object to perform a dodge action in air when the virtual object is in the flight state.

5. The method according to claim 1, further comprising:
switching the current movement state of the virtual object based on a trigger operation being performed on the action control element.

6. The method according to claim 2, further comprising:
switching the current movement state of the virtual object based on a trigger operation being performed on the action control element.

7. The method according to claim 6, wherein the switching the current movement state comprises:
switching the current movement state of the virtual object based on a long-press operation being performed on the first function sub-control element.

8. The method according to claim 7, wherein the switching the current movement state comprises:
based on the virtual object being in the flight state, controlling the virtual object to perform a landing action; and
based on the virtual object being in the non-flight state, controlling the virtual object to perform a takeoff action.

9. The method according to claim 2, further comprising:
controlling, based on a short-press operation being performed on the first function sub-control element, the virtual object to perform a non-flight-specific action.

10. The method according to claim 9, further comprising:
outputting for display a joystick operation control element, wherein
the first function sub-control element is a dodge sub-control element; and
the controlling the virtual object to perform the non-flight-specific action includes controlling, based on the short-press operation, the virtual object to perform a dodge action in a direction corresponding to a joystick operation of the joystick operation control element.

11. The method according to claim 2, wherein the second function sub-control element includes an upward flight sub-control element and a downward flight sub-control element, and the method further comprises:
controlling, based on a trigger operation being performed on the upward flight sub-control element, the virtual object to fly upward in the virtual environment; and
controlling, based on a trigger operation being performed on the downward flight sub-control element, the virtual object to fly downward in the virtual environment.

12. The method according to claim 11, wherein
the controlling the virtual object to fly upward includes controlling, based on a slide operation being performed on the upward flight sub-control element, the virtual object to fly upward in the virtual environment; and
the controlling the virtual object to fly downward includes controlling, based on a slide operation being performed on the downward flight sub-control element, the virtual object to fly downward in the virtual environment.

13. The method according to claim 12, wherein
the upward flight sub-control element is located above the first function sub-control element, and the downward flight sub-control element is located below the first function sub-control element;
the controlling the virtual object to fly upward in the virtual environment includes controlling, based on an upward slide operation from the first function sub-control element to the upward flight sub-control element, the virtual object to fly upward in the virtual environment; and
the controlling the virtual object to fly downward includes controlling, based on a downward slide operation from the first function sub-control element to the downward flight sub-control element, the virtual object to fly downward in the virtual environment.

14. The method according to claim 13, further comprising:
outputting for display a joystick operation control element, wherein
the controlling the virtual object to fly upward includes controlling, based on the upward slide operation from the first function sub-control element and the upward flight sub-control element and a joystick operation performed on the joystick operation control element, the virtual object to fly obliquely upward in a horizontal direction of the joystick operation in the virtual environment.

15. The method according to claim 13, further comprising:
outputting for display a joystick operation control element, wherein
the controlling the virtual object to fly downward includes controlling, based on the downward slide operation from the first function sub-control element and the downward flight sub-control element and a joystick operation performed on the joystick operation control element, the virtual object to fly obliquely downward in a horizontal direction of the joystick operation in the virtual environment.

16. The method according to claim 13, wherein
the upward flight sub-control element is represented as an upper edge indicator pattern, and the upward slide operation is from the first function sub-control element toward a position of the upper edge indicator pattern with a slide distance exceeding a slide distance threshold; and
the downward flight sub-control element is represented as a lower edge indicator pattern, and the downward slide operation is from the first function sub-control element toward a position of the lower edge indicator pattern with a slide distance exceeding the slide distance threshold.

17. A information processing apparatus, comprising:
processing circuitry configured to:
output for display a virtual scene of a virtual environment, the virtual scene including a virtual object located in the virtual environment;
control the virtual object to perform an action in the virtual environment; and
output for display an action control element in one of a plurality of forms based on a current movement state of the virtual object, wherein
the action control element is displayed in a first form of the plurality of forms based on the current movement state being a non-flight state, and
the action control element is displayed in a second form of the plurality of forms based on the current movement state being a flight state.

18. The information processing apparatus according to claim 17, wherein
the first form of the action control element includes a first function sub-control element; and
the second form of the action control element includes the first function sub-control element and a second function sub-control element.

19. A non-transitory computer-readable storage medium storing instructions which when executed by a processor cause the processor to perform:
outputting for display a virtual scene of a virtual environment, the virtual scene including a virtual object located in the virtual environment;
controlling the virtual object to perform an action in the virtual environment; and
outputting for display an action control element in one of a plurality of forms based on a current movement state of the virtual object, wherein
the action control element is displayed in a first form of the plurality of forms based on the current movement state being a non-flight state, and
the action control element is displayed in a second form of the plurality of forms based on the current movement state being a flight state.

20. The non-transitory computer-readable storage medium according to claim 19, wherein
the first form of the action control element includes a first function sub-control element; and
the second form of the action control element includes the first function sub-control element and a second function sub-control element.
